(19) United States
(12) Patent Application Publication
(10) Pub. No.: US 2026/0180368 A1
(43) Pub. Date: Jun. 25, 2026

(54) WIRELESS CHARGING IN AUTOMATED PARKING GARAGES

(71) Applicant: CHARGING ROBOTICS LTD., Tel Aviv (IL)

(72) Inventors: Hovav GILAN, Kadima (IL); Dor SHOSHANI, Tel-Aviv (IL); Roey HUBERMAN, Tel-Aviv (IL)

(21) Appl. No.: 19/128,879

(22) PCT Filed: Nov. 13, 2023
(86) PCT No.: PCT/IL2023/051164

§ 371 Date: May 9, 2025

Related U.S. Application Data
(60) Provisional application No. 63/383,493, filed on Nov. 13, 2022.

(51) Int. Cl. H02J 50/12; B60L 53/14; B60L 53/16

(52) U.S. Cl. CPC H02J 50/12; B60L 53/14; B60L 53/16

(57) ABSTRACT

Disclosed herein is a system for wireless power transmission (WPT) inductive charging batteries of an electric vehicle (EV) while parked in an automated parking garage, the system including primary coils and secondary coils. The primary coils are permanently attached to structural elements that define each of the parking spaces in the garage to which electricity is transferred from the grid. In non-pallet garages secondary coils are temporarily attached to the exterior of each EV that has to be charged by the system. In pallet garages the secondary coil is permanently attached to each pallet in the system during the initial installation of the system in the garage. In embodiments of the system the same supporting electronics are used for several primary coils. Embodiments of the system are configured to allow bi-directional, i.e. grid to vehicle (G2V) and vehicle to grid (V2G), transfer of power.

### FIELD OF THE INVENTION

The present invention is from the field of electric vehicles (EVs). Specifically the invention is directed to a system and method of charging the battery of the (EV). More specifically the invention is directed to a system and method of charging the battery while the EV is parked in an automated parking garage where there is no access to the electric vehicle in the parking space and it is not possible to connect the plug of the charger to the EV as usual.

### BACKGROUND OF THE INVENTION

Automated parking garages are mechanical systems which are designed to park large numbers of cars in minimum space.

Automated parking garages are generally classified as belonging to one of two groups:
Fully automated in which a computer controlled vehicle transport system handles all operations of the process after the driver exits the car and registers at an entrance to the parking garage.
Semi-automatic in which a computer controlled vehicle transport system moves the vehicle to and from a parking space within a garage but action by an attendant or the driver is required.

In these systems the driver brings his car to an entrance to the garage and completes a registration process by entering data into a computer of a control system of the garage using either an application on their smartphone. a vehicle infotainment system application, and/or an input terminal, i.e. keyboard and graphical user interface or touchscreen. After the registration process is completed, the vehicle parking system automatically transports the vehicle both horizontally and vertically to an appropriately sized empty bay in which the vehicle is parked.

There are many types of automated parking garages which have been designed to incorporate from as little as two cars up to over 2,000 vehicles. Different types of automated parking garages exist that have been constructed as free standing open framework structures, enclosed in dedicated buildings, or incorporated into residential, office, or commercial buildings. In a first type of automated parking garage (e.g. a shuttle, a silo, and a tower parking system) the vehicle is moved to a specific parking space and remains there until it is called for by the driver. In a second type of automated parking garage (e.g. a puzzle and a rail guided parking system) the vehicle is moved by the robotic transport system from one location to another in the garage like a piece on a chess board in order to insert or remove another vehicle to/from a neighboring parking space.

One of the services requested from operators of parking lots by drivers of an electric vehicle (EV) is to charge the battery of their EV while it is parked. To date no suitable charging system is available to provide this system in automated parking garages because of the complexity of moving cables around to plug in EVs parked at remote locations. Also once the vehicle has been parked in the garage there is no access to it for a person to connect a plug to the charging port. Also, a regular charging, for example at a ground level bay, would require disconnecting the charging vehicle in order to allow charging of another one.

It is therefore a purpose of the present invention to provide a system and method for charging electric vehicles in automated parking garages without a need for a person to connect the plug of the charger to the car.

Further purposes and advantages of this invention will appear as the description proceeds.

### SUMMARY OF THE INVENTION

Presented herein is a WPT system for wireless power transmission (WPT) inductive charging batteries of an electric vehicle (EV) while parked in an automated parking garage The WPT system comprising:
a) at least one primary coil;
b) at least one secondary coil;
c) a network of cables that transfer electricity from the grid to some or all of the parking spaces in the garage;
d) a charging cable that transfers electricity from the secondary coil to a charging point of the EV; and
e) a WPT control system configured to control the distribution of electricity in the garage.

The WPT system is characterized in that:
i) a primary coil is attached to structural elements that define each of the parking spaces to which electricity is transferred from the grid;
ii) in non-pallet garages a secondary coil is temporarily attached to the exterior of an EV that has to be charged by the system;
iii) in pallet garages the secondary coil is attached to one or more pallets in the in the garage.

In embodiments of the WPT system, the primary coil is attached to the structural elements of the garage that define the parking space at a known location and orientation relative to the EV that will be introduced into the parking space. In these embodiments of the WPT system the primary coil is installed at a location such that is one of: positioned behind, in front of, above, or on one or more sides of a parked EV.

In embodiments of the WPT system that is installed in a non-pallet garage, the secondary coil is attached to one of: the roof, window, windshield, side or the wheel of the EV. In these embodiments of the system the secondary coil is attached to the EV by a secondary coil unit comprising a base and adjustable positioning arms. These embodiments of the system comprise an alignment jig, which comprising a stand-in for the primary coil. The stand-in for the primary coil is configured to replicate the exact height, orientation, and location at which the primary coil is attached to the structural elements of the parking space and the positioning arms are configured to move the secondary coil in three dimensions to bring the plane of secondary coil exactly parallel to and a predetermined distance from the plane of the stand-in primary coil.

In embodiments of the WPT system that is installed in a pallet garage, the secondary coil is attached to at least one of: the front, back, side, top or bottom of the pallet.

In embodiments of the WPT system, the WPT control system is configured to use at least one proximity sensors, optical sensors, and test transfers of energy to verify the positioning of the transmitting and receiving coils relative to each other for optimal transfer of power.

In embodiments of the WPT system, the WPT control system is configured to manage charging prioritizing the charge order of the EVs, by deciding what charge capacity to deliver to each EV, and by setting the minimal charge capacity for each EV that will allow it to perform the planned driving route based on a set of predefined rules and on inputs given by the driver regarding their planned trip.

In embodiments of the WPT system, the same supporting electronics are used for several primary coils. In these embodiments of the WPT system there is no upper limit to the number primary coils that can be supported by the same electronics.

In embodiments of the WPT system, power is transferred from the grid to an EV as follows:
i) power is supplied from the grid electric supply to an AC/DC power supply, which is configured to convert the grid voltage to high power DC voltage;
ii) the DC voltage is transferred to a TX power board, which is configured to convert DC output from the AC/DC power supply to high frequency, high power pulses;
iii) output from TX power board enters a connection box which is configured to shunt the high frequency, high power pulses to one of many high frequency, high power cables;
iv) the high frequency, high power cables are configured to conduct high frequency, high power pulses from connection box 48 in turn to a transmitter induction coil;
v) the transmitter induction coils are configured to transmit high frequency, high power pulses through the air to corresponding receiver induction coils that are attached to EVs or to the pallets on which the EV is moved around the garage;
vi) each receiver induction coil is attached to an RX power board, which is configured to convert received high frequency, high power pulses to DCpower that is transferred to the battery in an EV via a charging cable.

Embodiments of the WPT system comprise a power topology configured to allow bi-directional transfer of power. These embodiments of the WPT system comprise a full bridge in both the TX power board and the RX power board,

In embodiments of the WPT system, the electronics in the system for bi-directional transmission of power employs active components. In these embodiments employing active switching components elevates the overall efficiency of the system and ensures that power is transmitted with minimal losses.

In embodiments of the WPT system, the WPT system is configured to allow bi-directional transfer of power, thereby enabling using an EV battery as an electricity storage device. In these embodiments the WPT system is configured such that excess energy stored in the EV battery can be returned wirelessly to the grid.

In embodiments of the WPT system, power is transferred from an EV to the electricity supply grid as follows:
i) DCenergy that is stored in the battery in an EV is transferred via charging cable to an RX power board, which is configured to convert received DC current to high frequency, high power pulses;
ii) the RX power board transmits the high frequency, high power pulses to an RX induction coil, which transmits the high frequency, high power pulses through the air to a corresponding TX induction coil;
iii) the high frequency, high power pulses are then transmitted from the TX induction coil through a high frequency, high power cable to a connection box;
iv) the connection box routes the high frequency high power pulses to a TX power board, which is configured to convert the high frequency, high voltage pulses to DC voltage;
v) from the TX power board the power is transferred to an AC/DC power supply which is configured to convert the DC voltage to AC grid voltage.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 schematically shows a secondary coil unit attached to the back side of the roof of an EV;

FIG. 2 schematically shows an alignment jig;

FIG. 3 schematically shows alignment jig in the correct position behind the EV in order to allow alignment of the secondary coil with the stand-in primary coil;

FIG. 4 schematically shows an EV and possible locations of a secondary coil on a pallet;

FIG. 5 schematically shows the flow of energy from the grid electricity supply 36 to the EV10 in the WPT system;

FIG. 6 is a schematic diagram showing a system configured to reduce the electronics needed to supply power to the primary coils as well as to allow V2G WPT in an automated parking garage; and

FIG. 7 is a schematic diagram of a connection box.

### DETAILED DESCRIPTION OF EMBODIMENTS OF THE INVENTION

As used herein, the term “electric vehicle” (abbreviated EV) is used to refer to “pure” electric vehicles, which are vehicles that utilize energy stored in batteries to provide all driving energy and to hybrid electric vehicles, which are vehicles that utilize a combination of fossil fuel energy and energy stored in batteries to provide driving energy. As used herein, the system of the invention is known as the “WPT system”, the control system of the WPT system is known as the “WPT control system”.

The WPT system and method for charging the battery of an electric vehicle (EV) disclosed herein is designed to be installed in both types of automated parking garage described above in which the (EV) is moved by the transport system of the garage. Aside from the requirement that EV's being charged should not be moved from the parking space into which they are initially stored during the entire time that they are being charged in order to insert or remove another vehicle from nearby parking spaces, the structural features of the transport system and garage computer system utilized to control the transport system and other aspects of the operation of the parking garage are immaterial to the invention. The present invention relates to a WPT system for distributing electricity to specified locations in the parking garage and to activating charging of EVs after they have been inserted into a parking space equipped for the purpose. All aspects of the charging process are handled by the WPT control system, which can be separate from the garage control system, although they might share information and some functions such as customer registration and billing.

The charging method utilized by the present system is wireless power transmission (WPT). In the WPT method a charge transmitter comprising a primary coil configured as a transmit coil (TX) and a secondary charge coil configured as a receive coil (RX) are configured and arranged to magnetically couple the two coils with each other. A changing magnetic field that is generated by the transmit coil is picked up by the receive coil which, in turn, induces an electromotive force in the receive coil. The generated electromotive force creates an oscillating current which, in the present system is transferred to charge the vehicle battery via a charging cable, which is connected on a first end to the output of the secondary coil. The charging cable has a plug on its second end that is inserted into the charging port on the EV. In other embodiments, the power is transmitted to a secondary coil (also referred to as an antenna, an antenna coil or an inductive coil), which is a component of the EV, usually located on the bottom of the chassis of the EV.

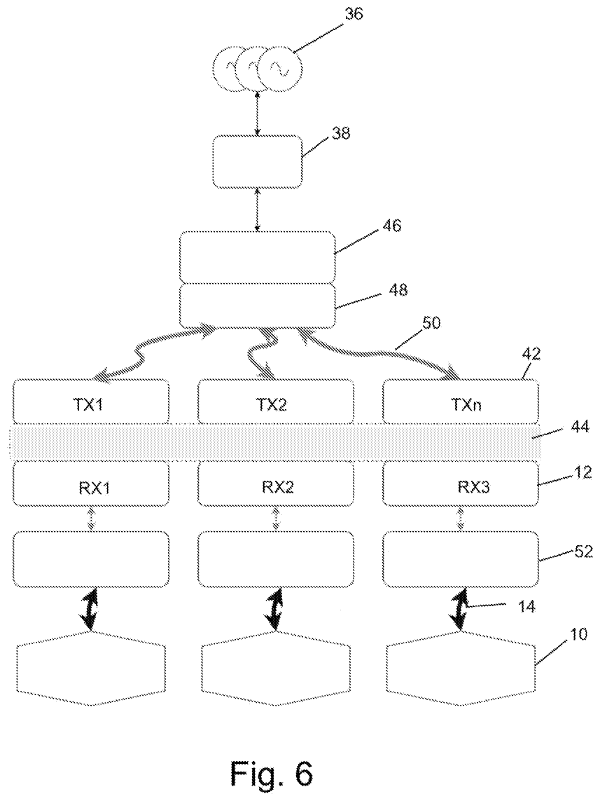

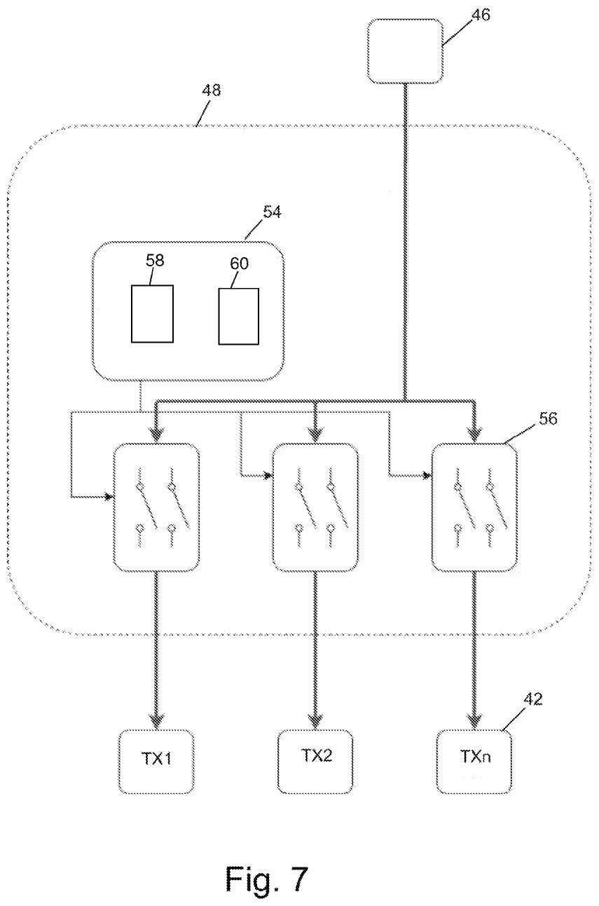

The infrastructure of the parking garage comprises a network of cables that are an integral part of the WPT system that transfer electricity from the grid to some or all of the parking spaces in the garage. In each of the spaces that are supplied with electricity is installed a primary coil system comprised of a primary coil connected to an electric circuit that includes components configured to start and stop transfer of electricity to the primary coil and components configured to communicate with the WPT control system and/or the computer of an EV located in the parking space. In embodiments that will be described herein below with respect to FIGS. 6 and 7, only the primary coils are installed at the location of the parking space. The electronics needed to supply the primary coils with electricity and to control charging the EV are located in a centralized location and are configured to support several primary coils. Depending, inter alia, on the arrangement of the structural elements of the garage that define the parking spaces, the primary coil can be installed at a location such that it is positioned behind, in front, above, below, or at the sides of a parked EV.

In order for the energy transfer to be efficient the two coils must have a specific orientation to each other. Since models of EV that are suitable for parking have different shapes and dimensions, all EVs can be parked by the vehicle transport system centered in the parking spaces pointed in the same direction, e.g. with the back of the car to the back of the parking place. The parking lots can also be configured such that, depending on the direction in which the EV is inserted into the parking space, either the front or rear wheels of the EV will be at the same location and distance relative to the primary coil. This can be achieved in many ways, e.g. by use of an optical sensor that signals the vehicle transport system that it is inserting the EV into the space when the wheels have reached a pre-determined location or by a physical barrier or depression into which the wheels will settle when at the desired location. The WPT system can use several methods, e.g. proximity sensors and optical sensors to verify the optimal positioning of the two coils relative to each other. Additionally, the WPT control system can execute a test transfer of energy in which the percentage of power transferred (or power lost) as measured by the secondary coil is used as an indication of the accuracy of alignment of the coils. In these ways, the primary coil can be attached to the structural elements at a location in a known orientation relative to that of an EV, e.g. relative to the wheels, that is introduced into the parking space and the control system of the charging system is able to confirm that the primary and secondary coils are properly aligned before beginning charging the EV.

When an EV arrives at the entrance to the parking garage before the automatic system takes over to begin the parking procedure, as part of the registration process the driver indicates whether the EV requires charging; alternatively, there can be an automatic system such as a smartphone application that is based on the charging level of the EV and other parameters (such as the parking time, the availability of charging stations etc.) that can offer the driver the charging services. After receiving the driver's instructions to charge the EV, the control system of the garage selects an empty parking space suitable for the model and charging requirements of the EV. Note that the software application can be configured to allow the registration process to be completed by the driver remotely prior to arriving at the parking garage. In some parking garages, for example those constructed for apartment buildings, the EV is normally parked when not being used and, the registration process for the anticipated next trip can be completed when returning the EV from each trip. The control system also activates the vehicle transport system of the garage to move the EV to the selected parking space. The charging control system then takes over and communicates instructions to the primary coil system regarding the electric power to deliver to the EV.

Charge power is the power in kW in which the EV is charged. This is how fast the EV is charged. Charge capacity is the quantity of electricity in kWh delivered to the EV. Charge capacity is charge power multiplied by the time the power is delivered.

Since there may not be enough electric power to charge all vehicles to full charge capacity in the required time, the WPT control system is configured to manage charging by prioritizing the charge order of the EVs, by deciding what charge capacity to deliver to each EV and by setting the minimal charge capacity for each EV that will allow it to perform the planned driving route. The WPT control system supplies each vehicle with the amount of electricity needed for the planned trip based on a set of predefined rules and on inputs given by the driver regarding their planned trip.

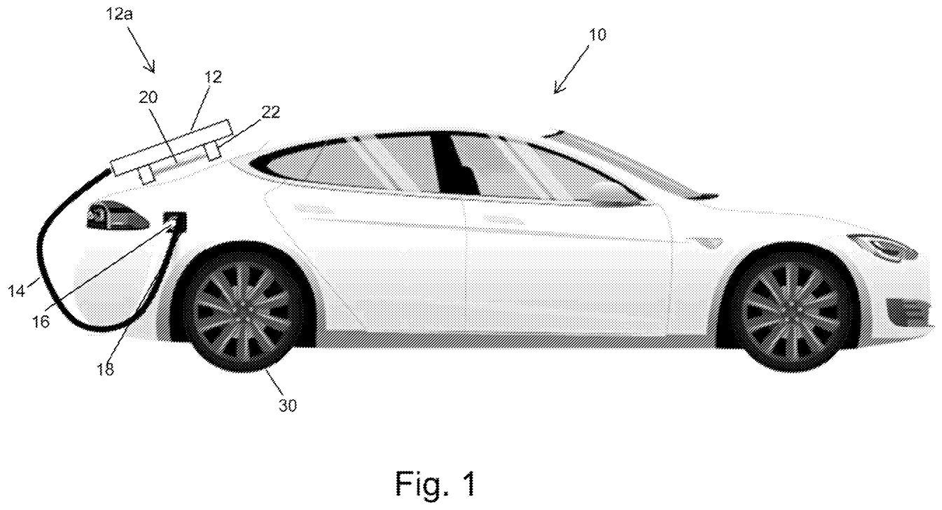

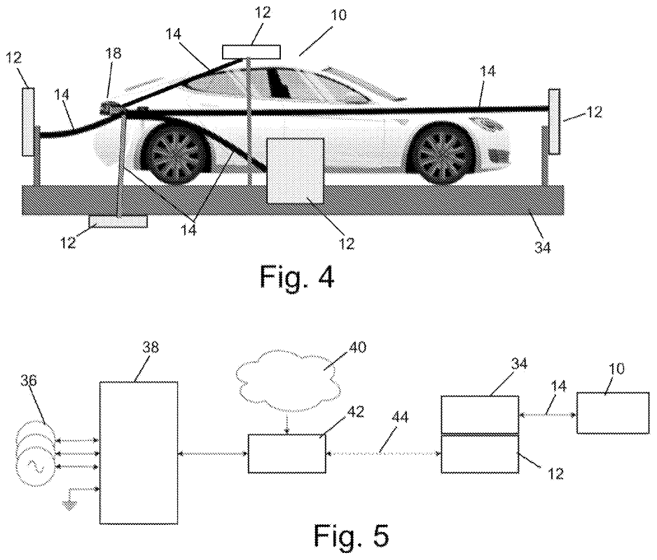

There are two different ways for positioning the secondary coil that depend on the robotic transport system used to move the EV around in the automated parking garage:
a) In some garages, designated as non-pallet garages herein, the robotic transport system is configured to either lift the EV or move it with its wheels on the ground. For this type of garage, the method of positioning of the secondary coil is described herein below with reference to FIGS. 1-3.
b) In some automated parking garages, designated as pallet garages herein, vehicles that enter the garage are driven onto pallets, which are then moved, with the vehicles on them to the designated parking space. For this type of garage, the method of positioning of the secondary coil in the present system, is to attach the secondary coil to the pallet in a permanent manner in the initial installation of the system in the garage. This is described herein below with reference to FIGS. 4-5.

In the case of an EV with a secondary coil that is a component of the EV located, for example, the bottom of the chassis, the primary coil is located on the pallet or on the floor of the parking space in a non-pallet garage.

In non-pallet parking garages, during or after the registration process, the driver or an attendant is then instructed by the WPT control system to attach a secondary coil unit to the back, front, side, wheel or top of the EV, depending on the known location of the primary coil the selected parking space.

FIG. 1 schematically shows a secondary coil unit 12a attached to the back side of the top of an EV 10. Secondary coil unit 12a comprises a base 20, positioning arms 22, secondary coil 12, and a charging cable 14. Base 20 is attached to EV 10 by, for example vacuum cups or magnets. Positioning arms 22 are articulated positioning arms comprising rigid tubes or rods with ball joints at the end of the rigid sections, which are locked in position by friction or set screws; thereby allowing the secondary coil 12 to be moved in three dimensions to align it with the primary coil. Charging cable 14 is connected at a first end to the secondary coil 12 and at a second end to a plug 16, which the driver or attendant, who can be a human or a robot or robotic system, is instructed to insert in the charging point 18 of the EV 10.

After attaching secondary coil unit 12a to EV 10, the driver or attendant is instructed to move an alignment jig to a known position relative to the EV 10 in order to adjust positioning arms 22 such that when the EV 10 is inserted into the selected parking space the primary and secondary coils will be oriented relative to each other in order to allow for efficient energy transfer between them. The alignment jig is needed in order to make sure that primary and secondary coils will be aligned for all vehicle types. In cases where the same types of vehicle are parked in parking spaces having the primary coil at the same location the alignment jig and process to position and adjust the angle of the secondary coil may not be required.

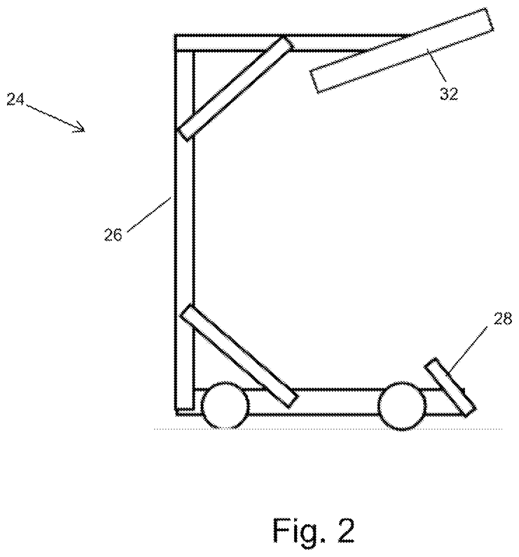

FIG. 2 schematically shows an alignment jig 24. Alignment jig 24 has a frame 26 constructed, for example from aluminum or steel profiles. At the end of horizontal profiles of the frame 26 that are close to the floor of the garage is attached at an angle an end plate 28. At the end of horizontal pieces of frame 26 at the top of the is attached a stand-in for the primary coil 32, i.e. a plate of material that replicates the exact height, and angle relative to the floor, and location at which the primary coil is attached to the structural elements at the rear of the selected parking space.

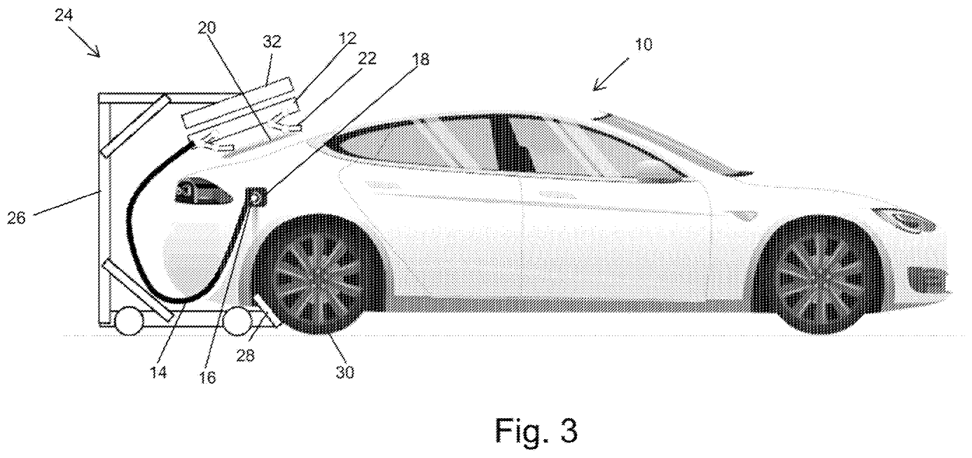

FIG. 3 schematically shows alignment jig 24 moved to the correct position behind EV 10 in order to allow alignment of secondary coil 12 with stand-in primary coil 32. In this position, end plate 28 is butted up against the back of the rear tires 30 of EV10 and the alignment jig 24 replicates the location of the structural elements of the parking space to which the primary coil is attached. The positioning arms 22 of secondary coil unit 22a are then manually adjusted to bring the plane of secondary coil 12 exactly parallel to and a predetermined distance from the plane of stand-in primary coil 32. In an alternative, but much more costly embodiment, electric motors and sensors can be employed to carry out the alignment.

After alignment, the alignment jig 24 is removed and the robotic transport system of the garage takes over to automatically move EV 10 horizontally and vertically, as necessary, to the specific empty parking space selected by the control system of the garage previously, which contains a primary coil located and oriented the same as stand-in primary coil 32. When the WPT control system receives notice from the robotic transport system that the EV 10 is parked in the parking space with its rear wheels the designated distance from the rear of the space, it is known that the primary and secondary coils are in the correct position relative to each other for efficient energy transfer and the WPT control system signals the primary coil system to begin transferring electricity to the secondary coil. When the battery of EV 10 is fully charged, then the primary coil system receives a signal to stop transfer of electricity either directly from the computer of EV10 or from the WPT control system. Data relating to the amount of energy transferred is measured and the measured quantity transmitted, e.g. via internet, to either the WPT control system or the control system of the garage for billing purposes.

Charging can be ceased once the EV battery is fully charged or charged to a different optimal charging level; such optimal level can be defined by the driver as a minimum level, or by the system based on a need of vacating a charging space for another EV, or other parameters that can be defined. Then, the automatic parking system can move the EV to a different bay in order to allow for another EV to use the bay that has the primary coil charging system.

When the driver returns to the garage and requests the return of his vehicle via the computer of a control system of the garage, the vehicle transport system removes the fully charged EV from the parking space and delivers it to an exit from the garage where the driver and/or attend unplugs the secondary coil 12 from the vehicle's charging point 18 and removes the secondary coil unit 12a from the vehicle before the driver drives off.

In summary, the present method for charging the battery of an electric vehicle (EV) in an automated non-pallet parking garage includes the following steps:
a) Permanently attach, at a known location and orientation relative to an EV that will be introduced into a parking space, a primary coil to structural elements in each parking space of the parking garage at which battery charging is to be provided;
b) The driver enters and parks the EV at the entrance to the garage;
c) The driver registers for the parking and battery charging service;
d) The driver and/or an attendant of the parking garage perform the following:
   i) Attach a secondary coil unit 12a at a designated location to the exterior of the vehicle 10;
   ii) Plug a charging cable 14 from the secondary coil 12 to the charging point 18 of the vehicle 10;
   iii) Bring an alignment jig 24 to the vehicle 10 and position the alignment jig 24 relative to the wheels 30 of the vehicle 10;
   iv) Adjust positioning arms 22 of the secondary coil unit 12a such that the plane of the secondary coil 12 exactly parallel to and a predetermined distance from the plane of a stand-in primary coil 32 on the frame 26 of the alignment jig 24;
   v) Driver leaves the garage
e) The vehicle transport system of the garage takes over to automatically move EV 10 horizontally and vertically, as necessary, to a preselected specific empty parking space containing a primary coil that is located and oriented the same as stand-in primary coil 32.
f) The WPT control system confirms that the primary and secondary coils are properly aligned and the primary coil system is activated to begin transferring electricity to the secondary coil 12;
g) When the battery of EV 10 is charged to the requested level, the primary coil system receives a signal from the computer of EV10 or the WPT control system to stop transfer of electricity;
h) The driver returns to the garage and requests the return of his vehicle 10 via a computer of the control system of the garage;
i) The automatic vehicle transport system removes the fully charged EV 10 from the parking space and delivers it to an exit from the garage;
j) The driver and/or an attendant of the parking garage perform the following:
   i) Unplug the secondary coil 12 from the vehicle's charging point 18; and
   ii) Remove the secondary coil unit 12a from the vehicle;
k) The driver enters EV 10 drives off.

In pallet garages the secondary coil, connected to its cable, is permanently connected to at least one of the front, back, side, top or bottom of the pallet as shown in FIG. 4. When the EV arrives at the entrance to the parking garage, it is driven onto a waiting pallet and the driver completes the same registration process as described above. After the registration process, driver or an attendant is instructed to insert the plug on the cable connected to the secondary coil on the pallet that corresponds to the location of the primary coil in the designated parking space into the charging port of the EV. The pallet with the EV on it is then transferred by the robotic transport system of the garage to the parking space that was selected by the control system of the garage.

In summary, the present method for charging the battery of an electric vehicle (EV) in an automated pallet parking garage includes the following steps:
a) Attach, at a known location and orientation relative to the possible location of an EV that will be introduced into a parking space, a primary coil to structural elements in parking spaces of the parking garage at which battery charging is to be provided;
b) Attach to pallets in the garage a secondary coil at one or more designated locations and orientations corresponding to the known locations and orientations of the primary coils in the parking spaces;
c) The driver enters and parks the EV at a designated location in the garage;
d) The driver registers for the parking and battery charging service;
e) The driver and/or an attendant of the parking garage drive the EV onto a pallet to which at least one secondary coil has been attached and plug a charging cable 14 from the secondary coil 12 to the charging point 18 of the vehicle 10;
f) the driver leaves the garage;
g) The vehicle transport system of the garage takes over to automatically move EV 10 horizontally and vertically, as necessary, to a preselected specific empty parking space containing a primary coil that is located and oriented to correspond with the location and orientation of the secondary coil attached to the pallet;
h) The WPT control system confirms that the primary and secondary coils are properly aligned and the primary coil is activated to begin transferring electricity to the secondary coil 12;
i) When the battery of EV 10 is charged fully or to the requested level, the primary coil system receives a signal from the computer of EV10 or the WPT control system to stop transfer of electricity;
j) The driver returns to the garage and requests the return of his vehicle 10 via a computer of the control system of the garage;
k) The automatic vehicle transport system removes the charged EV 10 from the parking space and delivers it to an exit from the garage;
l) The driver and/or an attendant of the parking garage unplug the secondary coil 12 from the vehicle's charging point 18; and
m) The driver enters EV 10 and drives off.

FIG. 4 schematically shows an EV 10 on a pallet 34. The figure is a composite view that shows possible locations at which secondary coils 12 could be attached to the front, side, rear, top. and front of pallet 12, such that the secondary coil 12 will efficiently receive power from the primary coil in the parking space selected for the EV10 can be electrically connected to the charging point 18 of EV10 via charging cable 16.

FIG. 5 schematically shows the flow of energy from the grid electricity supply 36 to the EV10 in the WPT system. From the grid electricity passes to a AC/DC power converter 38, which transfers DC electricity to the primary coil (TX) 42. TX 42 receives instructions from control system 40 of the garage regarding the charge capacity to deliver across air gap 44 to the secondary coil (RX) 12, which is mounted on pallet 34 and from RX 12 via charging cable 14 to EV 10.

EV 10 enters a non-pallet garage, energy flow from grid electricity supply 36 to EV 10 is the same as shown in FIG. 5, with the exception that there is no pallet 34 and charging cable 14 is connected to RX 12.

Note that the arrows that designate the direction of energy flow between components in this figure and other figures are double headed to indicate flow in both directions. This is because, will be discussed below the system can be configured for bi-directional WPT.

Another feature of the control system of the automated parking garage is a method of utilizing the same supporting electronics for several primary coils. This saves the cost of electronics and results in not requiring the electric circuits described above to be installed with each primary coil at every parking space in the garage.

FIG. 6 is a schematic diagram showing the WPT system configured to reduce the electronics needed to supply power to the primary coils in an automated parking garage and also to provide bi-directional transfer of power as will be described herein below.

Referring to FIG. 6 power is transferred from grid 36 to EV10 (G2V) as follows:
i) power, e.g. 230 VAC 3 phase, is supplied from grid electric supply 36 to an AC/DC power supply 38, which is configured to convert the grid voltage to high power DC voltage, e.g. 800 VDC,
ii) The DC voltage is transferred to a TX power board 46, which is configured to convert DC output from power supply 38 to high frequency, e.g. 80 KHz, high power pulses;
iii) Output from TX power board 46 enters connection box 48, which comprises a multiplexer to shunt the high frequency, high power pulses between many, n, high frequency, high power cables 50, one at a time;
iv) High frequency, high power cables 50 conduct high frequency, high power pulses from connection box 48 in turn to transmitter induction coils 42 (TX₁, TX₂ . . . TXn);
v) Transmitter induction coils 42 transmit power through the air 44 to corresponding receiver induction coils 12 that are attached to EVs or to the pallets on which the EV is moved around the garage;
vi) Each receiver induction coil 12 is attached to a RX power board 52 (RX₁, RX₂, . . . RXn), which is configured to convert received high frequency, high power pulses to DCpowe, e.g. 400-800 VDC, that is transferred to the battery in an EV 10 via charging cable 14.

It is noted that the number of transmitter induction coils supported by the architecture shown in FIG. 6 is unlimited, although for practical reasons it might be more efficient to divide the parking area into sections depending on the size of the parking garage with a separate system having the architecture shown in FIG. 6 providing power to all parking spaces in each section. Also it is noted that the numerical values for the parameters that are presented herein are given as examples and other values are possible.

FIG. 7 is a schematic diagram of the connection box 48 in FIG. 6. Connection box 48 connects the wireless charging converter system 46 separately to each of the transmitter conduction coils 42 (TX₁, TX₂ . . . TXn) through n switches 56. The switches 56 are individually opened or closed by means of a circuit board 54 that comprises a multiplexer 58 and communication components 60. The communication components 60 are in contact with the WPT control system 40, which sends instructions including which TX coil should be connected to the electricity supply, for how long, and in which order.

Because of the move to renewable electricity (wind, solar) in recent years, there has been created a huge need for electricity storage capabilities. Using the EV battery as an electricity storage device can contribute to bridging the gap between supply and demand of electricity. For this reason the presently described automated parking lot employs technology that allows the wireless electricity charging system to pass electricity in a wireless manner between the grid to the vehicle and between the vehicle to the grid (V2G).

The mechanism and economics of making V2G technology available to customers of the parking garage are illustrated by the following exemplary scenario: The driver parks her EV at night, when electricity prices are typically lowest) at a wireless charging/V2G spot in the automated parking garage and uses an application on her smartphone to allow transferring electricity from the grid to the EV according to her expected needs for the next days driving. The following day she returns the car to the parking garage in the late afternoon, when the cost of electricity is typically higher than at night. She again uses her application to allow transferring electricity above a certain level, e.g. 30% of the battery capacity from the EV to the grid. The system credits the driver's account or credit card with the amount of credit calculated according to the then electricity cost. Thus the driver's incentive is to charge her EV during times of lower electricity price and to sell back excess battery capacity at a higher price. At the macro level the system solves a problem of electricity storage, if a large number of EV's enable such storage and the system/grid only needs to buy electricity from the drivers at an attractive price.

In addition to the EV being charged in the parking garage other methods of charging an EV such as regenerative braking, solar, and infrastructure (roads) that charge the EV as it is parked or driving outside of the parking garage can be employed to increase the energy stored in the battery of the EV. Excess energy stored in the batteries can then be returned wirelessly to the grid as described above after the EV returns to the garage.

Bi-directional capability is achieved in the presently described system through the careful selection of the appropriate power topology and by incorporating hardware embedded software that runs on micro-controllers which are part of the WPT system and software solutions for and independent applications such as the activation of the process, credit or billing.

The description of FIG. 6 relates to WPT from grid to EV (G2V). This same topology, when adapted to “phase shift full bridge converter topology”, becomes bi-directional, i.e., can be used for both G2V and V2G.

The system power topology employed to allow bi-directional transfer of power is characterized by having a full bridge in both the TX power board 46 and the RX power board 52. While the electronics of the WPT system can employ either passive components, e.g. diodes, or active components, e.g. transistors, a most important feature of the system for G2V described hereinabove that is adapted for bi-directional transmission of power is that the electronics of the system employs active components that are supplemented with dedicated software. The use of active switching components, which are characterized by their low resistance, serve to elevate the overall efficiency of the system ensuring that power is transmitted with minimal losses. Another advantage of employing active components is their controllability, allowing the direction of the current within the system to be controlled. Other differences between one directional and bi-directional power transmission are needed, for example, power supply 38 must be able to convert both AC to DC and DC to AC. Another notable feature of the presently described system is that the precision of current flow in and out of the vehicle is achieved through the implementation of phase control on the RX side.

Referring to FIG. 6 power is transferred from EV10 to grid 36 (V2g) as follows:
i) DCenergy that is stored in the battery in an EV 10 is transferred via charging cable 14 to RX power board 52, which is configured to convert received DC current to high frequency, e.g., 80 KHz, high power, e.g., 800 VDC, pulses;
ii) the RX power board 52 transmits the pulses to an RX induction coil 12, which transmits the pulses through the air 44 to a corresponding TX induction coil 42;
iii) the high frequency, high power pulses are then transmitted from TX induction coil 42 through High frequency, high power cables 50 to connection box 48;
iv) the connection box routes the high frequency high power pulses to TX power board 46 where the high frequency, high voltage pulses are converted to DC voltage, e.g., 800 VDC;
v) from the TX power board 46 the power is transferred to AC/DC power supply 28 where the DC voltage is converted to AC voltage, e.g. 230 V 3 phase, that is fed back into the grid 36.

Although embodiments of the invention have been described by way of illustration, it will be understood that the invention may be carried out with many variations, modifications, and adaptations, without exceeding the scope of the claims.

1. A WPT system for wireless power transmission (WPT) inductive charging batteries of an electric vehicle (EV) while parked in an automated parking garage, the WPT system comprising:
a) at least one primary coil;
b) at least one secondary coil;
c) a network of cables that transfer electricity from the grid to some or all of the parking spaces in the garage;
d) a charging cable that transfers electricity from the secondary coil to a charging point of the EV; and
e) a WPT control system configured to control the distribution of electricity in the garage;
wherein:
i) a primary coil is attached to structural elements that define each of the parking spaces to which electricity is transferred from the grid;
ii) in non-pallet garages a secondary coil is temporarily attached to the exterior of an EV that has to be charged by the system;
iii) in pallet garages the secondary coil is attached to one or more pallets in the in the garage.

2. The WPT system of claim 1, wherein the primary coil is attached to the structural elements of the garage that define the parking space at a known location and orientation relative to the EV that will be introduced into the parking space.

3. The WPT system of claim 2, wherein the primary coil is installed at a location such that is one of: positioned behind, in front of, above, or on one or more sides of a parked EV.

4. The WPT system of claim 1, wherein in a non-pallet garage the secondary coil is attached to one of: the roof, window, windshield, side or the wheel of the EV.

5. The WPT system of claim 4, wherein the secondary coil is attached to the EV by a secondary coil unit comprising a base and adjustable positioning arms.

6. The WPT system of claim 5 comprising an alignment jig comprising a stand-in for the primary coil, wherein the stand-in for the primary coil is configured to replicate the exact height, orientation, and location at which the primary coil is attached to the structural elements of the parking space.

7. The WPT system of claim 6, wherein the positioning arms are configured to move the secondary coil in three dimensions to bring the plane of secondary coil exactly parallel to and a predetermined distance from the plane of the stand-in primary coil.

8. The WPT system of claim 1, wherein in a pallet garage the secondary coil is attached to at least one of: the front, back, side, top or bottom of the pallet.

9. The WPT system of claim 1, wherein WPT control system is configured to use at least one of: proximity sensors, optical sensors, and test transfers of energy to verify the positioning of the transmitting and receiving coils relative to each other for optimal transfer of power.

10. The WPT system of claim 1, wherein, the WPT control system is configured to manage charging by prioritizing the charge order of the EVs, by deciding what charge capacity to deliver to each EV, and by setting the minimal charge capacity for each EV that will allow it to perform the planned driving route based on a set of predefined rules and on inputs given by the driver regarding their planned trip

11. The WPT system of claim 1, wherein the same supporting electronics are used for several primary coils.

12. The WPT system of claim 11, wherein there is no upper limit to the number of primary coils that can be supported by the same electronics.

13. The WPT system of claim 12, wherein power is transferred from grid to an EV as follows:
i) power is supplied from the grid electric supply to an AC/DC power supply, which is configured to convert the grid voltage to high power DC voltage;
ii) the DC voltage is transferred to a TX power board, which is configured to convert DC output from the AC/DC power supply to high frequency, high power pulses;
iii) output from TX power board enters a connection box which is configured to shunt the high frequency, high power pulses to one of many high frequency, high power cables;
iv) the high frequency, high power cables are configured to conduct high frequency, high power pulses from connection box 48 in turn to a transmitter induction coil;
v) the transmitter induction coils are configured to transmit high frequency, high power pulses through the air to corresponding receiver induction coils that are attached to EVs or to the pallets on which the EV is moved around the garage;
vi) each receiver induction coil is attached to an RX power board, which is configured to convert received high frequency, high power pulses to DC power that is transferred to the battery in an EV via a charging cable.

14. The WPT system of claim 13, comprising a power topology configured to allow bi-directional transfer of power.

15. The WPT system of claim 14, wherein the system power topology employed to allow bi-directional transfer of power comprises a full bridge in both the TX power board and the RX power board.

16. The WPT system of claim 15, wherein the electronics in the WPT system for bi-directional transmission of power employs active components.

17. The WPT system of claim 16, wherein active switching components are employed to elevate the overall efficiency of the WPT system and ensure that power is transmitted with minimal losses.

18. The WPT system of claim 14, wherein the WPT system configured to allow bi-directional transfer of power enables using an EV battery as an electricity storage device.

19. The WPT system of claim 18 configured such that excess energy stored in the EV battery can be returned wirelessly to the grid.

20. The WPT system of claim 14, wherein power is transferred from an EV to the electricity supply grid as follows:
i) DC energy that is stored in the battery in an EV is transferred via charging cable to an RX power board, which is configured to convert received DC current to high frequency, high power pulses;
ii) the RX power board transmits the high frequency, high power pulses to an RX induction coil, which transmits the high frequency, high power pulses through the air to a corresponding TX induction coil;
iii) the high frequency, high power pulses are then transmitted from the TX induction coil through a high frequency, high power cable to a connection box;
iv) the connection box routes the high frequency high power pulses to a TX power board, which is configured to convert the high frequency, high voltage pulses to DC voltage;
v) from the TX power board the power is transferred to an AC/DC power supply which is configured to convert the DC voltage to AC grid voltage.
